(19) United States
(12) Patent Application Publication
(10) Pub. No.: US 2015/0089118 A1
(43) Pub. Date: Mar. 26, 2015

(54) METHODS, SYSTEMS, AND COMPUTER READABLE MEDIA FOR PARTITION AND CACHE RESTORE

(71) Applicant: SANDISK TECHNOLOGIES INC., Milpitas, CA (US)

(72) Inventors: Hyun Mun In, Sunnyvale, CA (US); Shai Traister, Sunnyvale, CA (US); Gregory Louis Stevens, Scotts Valley, CA (US)

(21) Appl. No.: 14/033,353

(22) Filed: Sep. 20, 2013

(51) Int. Cl. G06F 3/06; G06F 12/08

(52) U.S. Cl. CPC G06F 3/0647; G06F 12/0866; G06F 3/0604; G06F 3/0685
USPC 711/103; 711/165; 711/113

(57) ABSTRACT

Methods, systems, and computer readable media for partition and cache restore are disclosed. According to one aspect, a method for partition and cache restore includes, in a computing platform having a mass storage device and a non-volatile cache storage device that operates as a cache for the mass storage device: providing, in a first location within the mass storage device, a first image of data; providing, in a second location within the mass storage device, a second image of data; copying the first image of data from the first location within the mass storage device to a third location within the mass storage device; and copying the second image of data from the second location within the mass storage device into the non-volatile cache storage device.

### TECHNICAL FIELD

The subject matter described herein relates to methods and systems for restoration or recovery of mass storage devices. More particularly, the subject matter described herein relates to methods, systems, and computer readable media for partition and cache restore.

### BACKGROUND

To improve performance of personal computers or other computing systems, traditional hard disk drives (HDDs), which have relatively large capacity but are relatively slow, may be combined with solid state drives (SDDs), which have relatively small capacity but are relatively fast. These so-called “dual drive” solutions may use the SSD as a cache for data coming from or going to the HDD. Dual drive caching solutions which include a HDD combined with either a small capacity caching Solid State Drive (SSD) or a larger capacity Solid State Hard Drive (SSHD) show significant performance increase compared to HDD alone when used with appropriate caching software/algorithm solution.

When setting up a newly purchased or received system, users have a better “out-of-box” experience if the original equipment manufacturer (OEM) or equipment supplier has pre-loaded the software onto both the HDD and the SSD/SSHD, which is colloquially referred to as “pinning” the software.

Many OEM PC vendors have the original OS in a hidden partition to be used as system recovery for either partial or full recovery. When this recovery is performed by conventional dual drive deployments, data in the HDD may be restored to the original pinned or preloaded state, but data in the caching SSD is not restored to the original pinned/pre-loaded state, however. As a result, users will not notice system improvement until the caching software begins to collect enough data to optimize the cache. The same problem occurs when a user restores a system from a previously-created backup: the data in the HDD may be restored but the caching information is not. In either scenario, until the cache is optimized, performance of the restored system may suffer.

Accordingly, in light of these disadvantages associated with conventional dual-drive implementations, there exists a need for methods, systems, and computer readable media for partition and cache restore.

### SUMMARY

According to one aspect, the subject matter described herein includes a method for partition and cache restore. The method includes, in a computing platform having a mass storage device and a non-volatile cache storage device that operates as a cache for the mass storage device: providing, in a first location within the mass storage device, a first image of data; providing, in a second location within the mass storage device, a second image of data; and copying the first image of data from the first location within the mass storage device to a third location within the mass storage device and copying the second image of data from the second location within the mass storage device into the cache storage device.

According to another aspect, the subject matter described herein includes a system for partition and cache restore. The system includes a computing platform having a mass storage device that contains a first image of data in a first location within the mass storage device and a second image of data in a second location within the mass storage device, and a non-volatile cache storage device that operates as a cache for the mass storage device. The computing platform is configured to copy the first image of data from the first location within the mass storage device to a third location within the mass storage device and copy the second image of data from the second location within the mass storage device into the cache storage device.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings, wherein like reference numerals represent like parts, of which:

FIG. 1 is a block diagram illustrating an exemplary system for partition and cache restore according to an embodiment of the subject matter described herein;

FIG. 2 is a flow chart illustrating an exemplary process for partition and cache restore according to an embodiment of the subject matter described herein;

FIG. 3 is block diagram showing in more detail the image copy operations according to an embodiment of the subject matter described herein;

FIGS. 4A and 4B illustrate a portion of partition and cache restore according to an embodiment of the subject matter described herein; and

FIGS. 5A and 5B illustrate a portion of partition and cache restore according to another embodiment of the subject matter described herein.

### DETAILED DESCRIPTION

In accordance with the subject matter disclosed herein, systems, methods, and computer readable media for partition and cache restore are provided. Reference will now be made in detail to exemplary embodiments of the present invention, examples of which are illustrated in the accompanying drawings. Wherever possible, the same reference numbers will be used throughout the drawings to refer to the same or like parts.

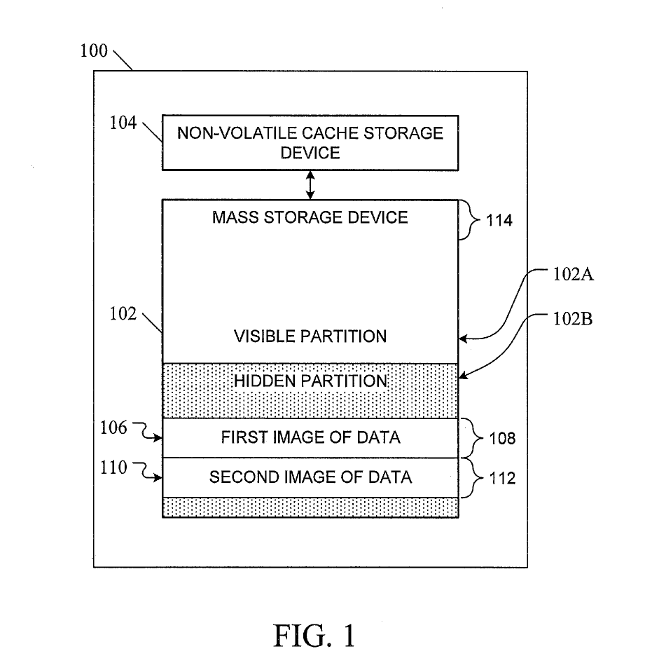

FIG. 1 is a block diagram illustrating an exemplary system for partition and cache restore according to an embodiment of the subject matter described herein. In the embodiment illustrated in FIG. 1, the system includes a computing platform 100 having a mass storage device 102 and a non-volatile cache storage device 104 that operates as a cache for mass storage device 102. Examples of computing platform 100 include, but are not limited to, personal computers, mobile devices, smart appliances, office systems, industrial controllers, and devices that execute software or process data. In one embodiment, mass storage device 102 may be a hard disk drive, an array of drives, or other mass storage entity. In one embodiment, cache storage device 104 may be a solid state drive (SSD) or other device suitable to operate as a non-volatile cache for mass storage device 102.

In one embodiment, mass storage device 102 and cache storage device 104 are separate units, e.g., each with its own interface to the host system. Alternatively, mass storage device 102 and cache storage device 104 may be components within a single storage entity, e.g., both devices may be contained within a single case which has a single interface to the host system. Examples of single storage entities containing both mass storage and non-volatile cache storage include, but are not limited to solid state hard disk drives (SSHD) and hybrid hard disk drives (HHDD).

The principles described herein are not limited to the above-described configurations, but apply to any configuration having both mass storage and non-volatile cache storage devices, including configurations in which the mass storage device is redundant array of independent disks (RAID), configurations in which the cache storage device is shared among multiple mass storage devices, and configurations in which the cache storage device is distributed across multiple physical devices, to name a few examples. In one embodiment, cache storage device may include volatile storage.

In the embodiment illustrated in FIG. 1, mass storage device 102 contains a first image of data 106 in a first location 108 within mass storage device 102 and a second image of data 110 in a second location 112 within mass storage device 102. In one embodiment, first image of data 106 may be portions of the operating system (OS), applications, or other data. In one embodiment, second image of data 110 may be the contents of cache storage device 104 after cache optimization. Thus, in one embodiment, second image of data 110 may include portions of the first image of data 106 and/or metadata used by cache storage device 104, e.g., to describe attributes of those portions.

Computing platform 100 is configured to perform a partition and cache restore operation that includes copying first image of data 106 from first location 108 to a third location 114 within mass storage device 102 and copying second image of data 110 from second location 112 into cache storage device 104.

Thus, in contrast to conventional systems that restore only the contents of a hard disk drive or other mass storage device, computing platform 100 is configured to restore at least some of the contents of the cache within cache storage device 104. By restoring not only the contents of a hard disk drive but also the contents of the cache, computing platform 100 is immediately put into a cache optimization state that conventional systems would achieve only after some amount of operation time. The result for the user is that computing platform 100 may feel more responsive because often-used data is present in the cache immediately after the restore.

In one embodiment, first location 108 and second location 112 within mass storage device 102 are hidden, e.g., located in a hidden partition or partitions, in order to protect them from accidental or intentional overwrite during operation of computing platform 100. In the embodiment illustrated in FIG. 1, for example, mass storage device 102 is divided into a visible partition 102A and a hidden partition 102B, in which first and second images of data 106 and 110 are stored. As will be described in more detail below, more than two images of data may be stored within mass storage device 102.

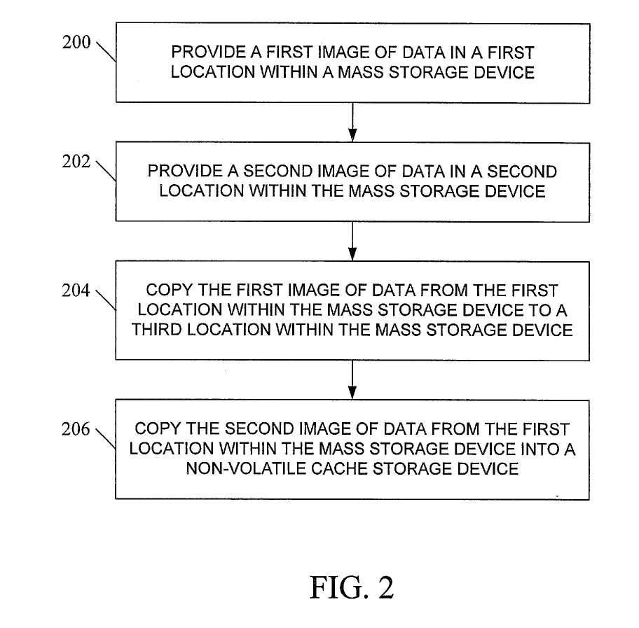

FIG. 2 is a flow chart illustrating an exemplary process for partition and cache restore according to an embodiment of the subject matter described herein. This process will now be described with reference to FIGS. 1 and 2.

In the embodiment illustrated in FIG. 2, at step 200, a first image of data is provided in a first location within a mass storage device that is part of a computing platform that also includes a non-volatile cache storage device that operates as a cache for the mass storage device. In FIG. 1, for example, first image 106 is stored at first location 108 within mass storage device 102. In one embodiment, first image 106 may be a clean copy of an operating system installation or a restore point created by a backup operation.

At step 202, a second image of data is provided in a second location within the mass storage device. In FIG. 1, for example, second image 110 may be stored at second location 112 within mass storage device 102. In one embodiment, second image 110 may be the contents of non-volatile cache storage device 104 as it exists after computing platform 100 has been operating for enough time to allow the cache to become optimized.

At step 204, the first image of data is copied from the first location within the mass storage device to a third location within the mass storage device. In FIG. 1, for example, first image 106 may be copied from first location 108 to third location 114 within mass storage device 102.

At step 206, the second image of data is copied from the second location within the mass storage device into the non-volatile cache storage device. In FIG. 1, for example, second image 110 may be copied from second location 112 of mass storage device 102 into non-volatile cache storage device 104. In one embodiment, second image 110 is bulk copied into cache storage device 104, in contrast to the gradual transfer of data into a cache that occurs during the course of normal operation.

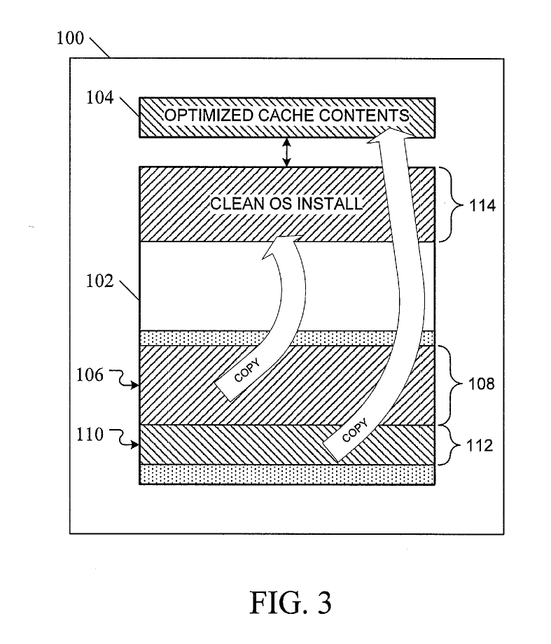

FIG. 3 is block diagram showing in more detail the image copy operations according to an embodiment of the subject matter described herein. In the embodiment illustrated in FIG. 3, first image of data 106 is a copy of the OS as it would be after a clean install, and second image of data 110 is a copy of the contents of cache storage device 104 as they would exist after computing platform 100 has been in operation for long enough for the cache data within cache storage device 104 to be optimized. By copying the clean OS install from first location 108 to third location 114 and copying the optimized cache contents from second location 112 into cache storage device 104, computing platform 100 is not only provided with a clean OS install but also put into a cache-optimized state immediately. Because computing platform 100 is immediately put into a cache-optimized state, computing platform 100 can take advantage of the performance increases that a cache provides without having to first wait for the cache to fill and optimize during the course of operation.

The example in which the first image of data contains a portion of an OS and the second image of data contains the data that would be contained in an optimized cache is a convenient one to use for the purposes of illustration (and will be used for the purposes of additional illustration below), but the subject matter described herein is not limited to only those kinds of data. First image of data 106, for example, may be application data, user data, system data, search index data, device driver data, and indeed may be any kind of data that may be present within a mass storage device such as mass storage device 102. Likewise, second image of data 110 may be any type of data that may be present within non-volatile cache storage device 104.

Continuing with the example illustrated in FIG. 3, in which first image of data 106 is a clean OS install and second image of data 110 is optimized cache contents, there are several scenarios by which the first and second images of data a provided to mass storage device 102.

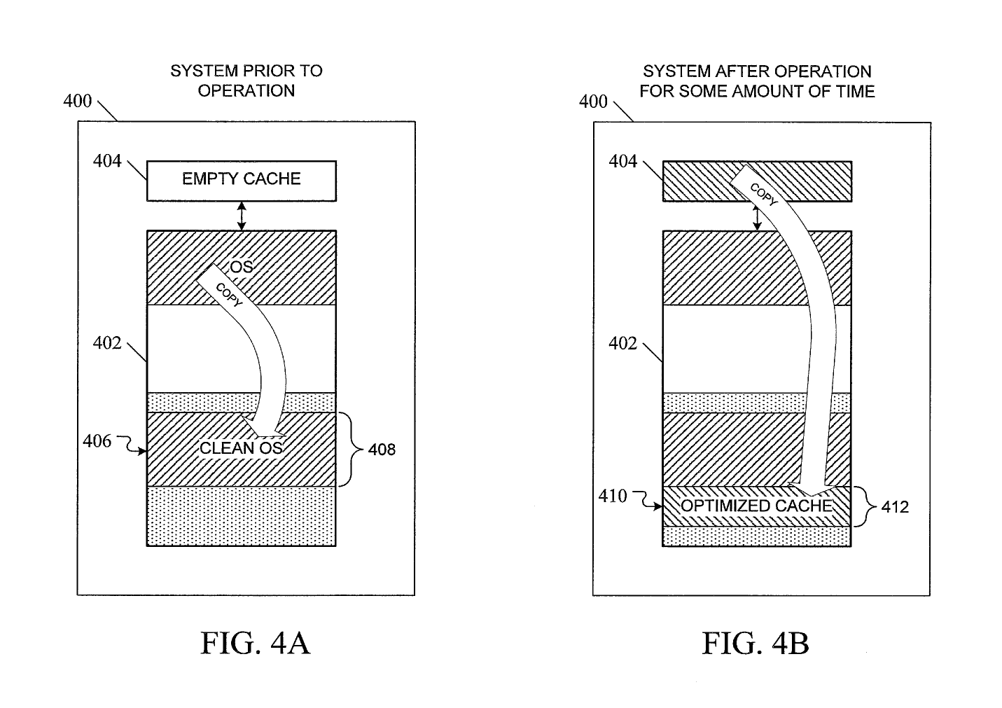

In one scenario, the first and second images 106 and 110 may be provisioned to mass storage device 102 prior to deployment of computing platform 100. For example, an original equipment manufacturer, or “OEM”, may pre-load mass storage device 102 by placing a copy of an operating system, for example, in the first location 108 and placing cache data, which may include portions of the OS along with cache meta data, into second location 112. This is illustrated in FIGS. 4A and 4B.

FIGS. 4A and 4B illustrate a portion of partition and cache restore according to an embodiment of the subject matter described herein. FIG. 4A shows a system after a clean OS install but prior to operation (FIG. 4A) and the same system after operation for some amount of time, e.g., enough time for the cache to optimize (FIG. 4B.) In FIG. 4A, for example, the OEM may prepare a computing platform 400 that uses a non-volatile cache storage device 404 that is the same or similar to non-volatile cache storage device 104 in target system 100. The OEM may then and load an operating system, applications, or other data onto system 400's mass storage device 402. Before allowing the system to operate, however, a copy of the OS after a clean install 406 may be copied into location 408 within mass storage device 402. In FIG. 4B, system 400 has been allowed to operate enough time that the cache data and metadata stored within the cache storage device has had a chance to be optimized. A copy of the optimized cache data 410 may be copied into location 410 within mass storage device 402. These images 406 and 410 may be used as the source for first and second images 106 and 110 of computing system 100.

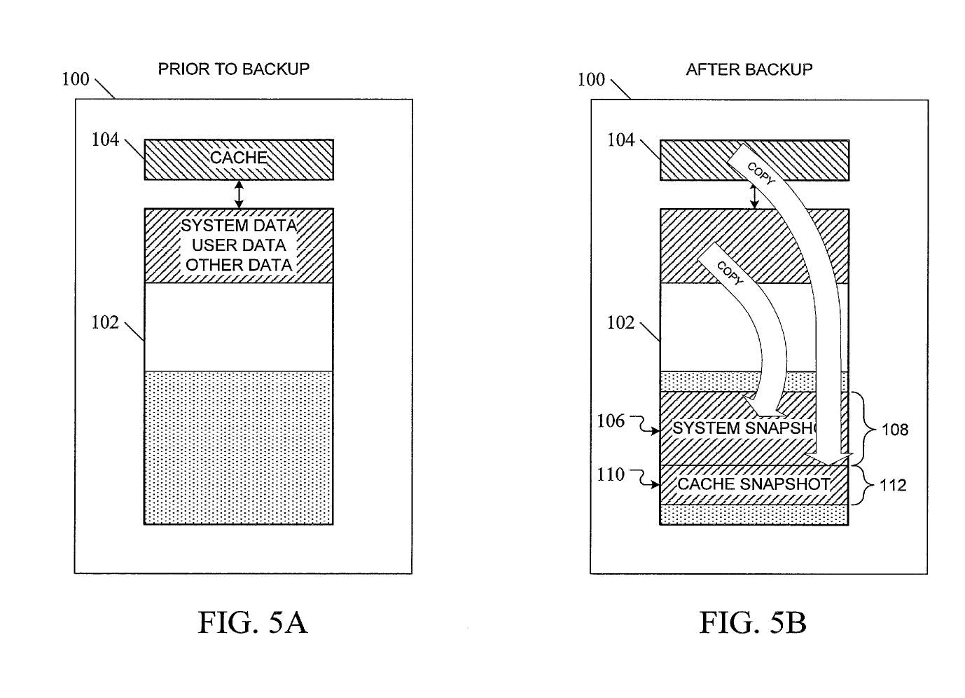

In another scenario, first and second images 106 and 110 may be stored to mass storage device 102 by a user of computing platform 100, such as during a back-up operation. This is illustrated in FIGS. 5A and 5B.

FIGS. 5A and 5B illustrate a portion of partition and cache restore according to another embodiment of the subject matter described herein, showing a system prior to backup (FIG. 5A) and after backup (FIG. 5B.) In FIG. 5A, mass storage device 102 of computing platform 100 may contain system data (e.g., OS, device drivers, kernel extensions, configuration files, applications, etc.), user data (user account information, user files, user programs, etc.), and other data (application configuration files, databases, shared files, etc.) Cache storage device 104 may contain optimized cache data, FIG. 5B shows the result of a user-initiated backup operation (which may also be referred to as “creating a restore point.”) As shown in FIG. 5B, some or all of the system, user, and other data may be stored as a system snapshot 106 into location 108 of mass storage device 102, and some or all of the contents of cache storage device 104 may be stored as a cache snapshot 110 into location 112 of mass storage device 102.

In the embodiment illustrated in FIGS. 5A and 5B, the system and cache snapshots correspond to first image of data 106 and second image of data 110, respectively, of FIG. 1, but that need not be the case. For example, the user-initiated backup operation shown in FIGS. 5A and 5B may place system and cache snapshots into locations other than locations 108 and 112. That is, mass storage device 102 may contain first and second images of data that were provided by an OEM and also third and fourth images of data that represent the results of a backup operation. Thus, in one embodiment, mass storage device 102 may contain multiple sets of images of data. For example, an OEM may provision multiple installations of an OS (e.g., home, small business, commercial.) Likewise, a user may make multiple backups or restore points. In one embodiment, a user requesting a backup may be asked whether they want to create a new restore or overwrite an older restore point. Backups may be happen without requiring user initiation, such as automated backups. The principles of the subject matter described herein are not limited to the examples described herein—the ability to pre-load data into a cache storage device and thus reap the benefits of cached data immediately rather than having to wait for the cache to optimize can provide a performance benefit in nearly any situation.

There are a number of advantages of the subject matter disclosed herein. Users will perceive the performance benefits of partition and cache restore immediately, and will not have to wait for the caching software to learn again from its restored state. This means that users will experience “fresh out of the box” performance after a recovery or restoration. The principles described herein also would be of great benefit in scenarios where computers are completely refreshed periodically, such as in shops and libraries or other places where computers may be provided for use by the public.

It will be understood that various details of the subject matter described herein may be changed without departing from the scope of the subject matter described herein. Furthermore, the foregoing description is for the purpose of illustration only, and not for the purpose of limitation.

What is claimed is:

1. A method for partition and cache restore, the method comprising:
in a computing platform having a mass storage device and a non-volatile cache storage device that operates as a cache for the mass storage device:
providing, in a first location within the mass storage device, a first image of data;
providing, in a second location within the mass storage device, a second image of data; and
copying the first image of data from the first location within the mass storage device to a third location within the mass storage device and copying the second image of data from the second location within the mass storage device into the non-volatile cache storage device.

2. The method of claim 1 wherein the first and second locations within the mass storage device are hidden.

3. The method of claim 1 wherein the mass storage device comprises a hard disk drive (HDD).

4. The method of claim 1 wherein the non-volatile cache storage device comprises a solid state drive (SSD).

5. The method of claim 1 wherein the mass storage device and the non-volatile cache storage device are components within a storage entity having a single host interface.

6. The method of claim 1 wherein the second image comprises contents of the non-volatile cache storage device after cache optimization.

7. The method of claim 1 wherein the second image comprises portions of data from the first image of data.

8. The method of claim 7 wherein the second image comprises metadata used by the non-volatile cache storage device and that describes attributes of the portions of data from the first image of data.

9. The method of claim 1 wherein providing the first and second images comprises provisioning the first and second images to the mass storage device prior to deployment of the computing platform.

10. The method of claim 1 wherein providing the first and second images comprises storing the first and second images to the mass storage device as part of a backup operation.

11. The method of claim 1 wherein copying the first and second images of data comprise part of an initialization or restore procedure.

12. A system for partition and cache restore, the system comprising:
a computing platform having:
a mass storage device that contains a first image of data in a first location within the mass storage device and a second image of data in a second location within the mass storage device; and
a non-volatile cache storage device that operates as a cache for the mass storage device,
wherein the computing platform is configured to copy the first image of data from the first location within the mass storage device to a third location within the mass storage device and copy the second image of data from the second location within the mass storage device into the non-volatile cache storage device.

13. The system of claim 12 wherein the first and second locations within the mass storage device are hidden.

14. The system of claim 12 wherein the mass storage device comprises a hard disk drive (HDD).

15. The system of claim 12 wherein the non-volatile cache storage device comprises a solid state drive (SSD).

16. The system of claim 12 wherein the mass storage device and the non-volatile cache storage device are components within a storage entity having a single host interface.

17. The system of claim 12 wherein the second image comprises contents of the non-volatile cache storage device after cache optimization.

18. The system of claim 12 wherein the second image comprises portions of data from the first image of data.

19. The system of claim 18 wherein the second image comprises metadata used by the non-volatile cache storage device and that describes attributes of the portions of data from the first image of data.

20. The system of claim 12 wherein the first and second images are provisioned to the mass storage device prior to deployment of the computing platform.

21. The system of claim 12 wherein the first and second images are stored to the mass storage device as part of a backup operation.

22. A non-transitory computer readable medium having stored thereon executable instructions that when executed by the processor of a computer control the computer to perform steps comprising:
in a computing platform having a mass storage device and a non-volatile cache storage device that operates as a cache for the mass storage device:
providing, in a first location within the mass storage device, a first image of data;
providing, in a second location within the mass storage device, a second image of data; and
copying the first image of data from the first location within the mass storage device to a third location within the mass storage device and copying the second image of data from the second location within the mass storage device into the non-volatile cache storage device.
